(19) United States
(12) Patent Application Publication
(10) Pub. No.: US 2026/0211969 A1
(43) Pub. Date: Jul. 23, 2026

(54) COMPUTE NODE EMBEDDINGS FOR RECOMMENDATION SYSTEM USING RICCI FLOWS AND GRAPH STATISTICS

(71) Applicant: Dell Products L.P., Round Rock, TX (US)

(72) Inventors: Priyanka Pathak, Bengaluru (IN); Saurabh Jha, Leander, TX (US)

(21) Appl. No.: 19/033,279

(22) Filed: Jan. 21, 2025

(51) Int. Cl. G06F 17/16

(52) U.S. Cl. CPC G06F 17/16

(57) ABSTRACT

A method for managing a graphical dataset includes generating a feature matrix for each node of a plurality of nodes in the graphical dataset, wherein the graphical dataset comprises the plurality of nodes and relationships between each of the plurality of nodes, generating a Laplacian matrix for each node of the plurality of nodes, generating a resistance matrix for each pair of nodes in the plurality of nodes using a Ricci curvature applied to the Laplacian matrix, performing a graphical restructuring of the graphical dataset based on the resistance matrix, wherein the graphical restructuring comprises modifying at least one of the relationships, and performing a node remediation action on at least one node in the graphical dataset based on the graphical restructuring.

### BACKGROUND

Graphical datasets may represent thousands or millions of nodes and inter-connected relationships between the nodes. Node embeddings of such graphical datasets may be time consuming. The processing of the graphical datasets to generate the node embeddings may be a contributing factor to the time taken to apply the node embeddings.

### BRIEF DESCRIPTION OF DRAWINGS

Certain embodiments of the invention will be described with reference to the accompanying drawings. However, the accompanying drawings illustrate only certain aspects or implementations of the invention by way of example and are not meant to limit the scope of the claims.

FIG. 1 shows a diagram of a system in accordance with one or more embodiments of the invention.

FIG. 2 shows a diagram of a dataset embedding agent in accordance with one or more embodiments of the invention.

FIG. 3 shows a flowchart of a method for performing a graphical rewiring in accordance with one or more embodiments of the invention.

FIG. 4 shows a diagram of a computing device in accordance with one or more embodiments of the invention.

### DETAILED DESCRIPTION

Specific embodiments will now be described with reference to the accompanying figures. In the following description, numerous details are set forth as examples of the invention. It will be understood by those skilled in the art that one or more embodiments of the present invention may be practiced without these specific details, and that numerous variations or modifications may be possible without departing from the scope of the invention. Certain details known to those of ordinary skill in the art are omitted to avoid obscuring the description.

In the following description of the figures, any component described with regard to a figure, in various embodiments of the invention, may be equivalent to one or more like-named components described with regard to any other figure. For brevity, descriptions of these components will not be repeated with regard to each figure. Thus, each and every embodiment of the components of each figure is incorporated by reference and assumed to be optionally present within every other figure having one or more like-named components. Additionally, in accordance with various embodiments of the invention, any description of the components of a figure is to be interpreted as an optional embodiment, which may be implemented in addition to, in conjunction with, or in place of the embodiments described with regard to a corresponding like-named component in any other figure.

Throughout this disclosure, elements of figures may be labeled as A to N, A to P, A to M, or A to L. As used herein, the aforementioned labeling means that the element may include any number of items, and does not require that the element include the same number of elements as any other item labeled as A to N, A to P, A to M, or A to L. For example, a data structure may include a first element labeled as A and a second element labeled as N. This labeling convention means that the data structure may include any number of the elements. A second data structure, also labeled as A to N, may also include any number of elements. The number of elements of the first data structure and the number of elements of the second data structure may be the same or different.

As used herein, the phrase operatively connected, operably connected, or operative connection, means that there exists between elements, components, and/or devices a direct or indirect connection that allows the elements to interact with one another in some way. For example, the phrase ‘operably connected’ may refer to any direct (e.g., wired directly between two devices or components) or indirect (e.g., wired and/or wireless connections between any number of devices or components connecting the operably connected devices) connection. Thus, any path through which information may travel may be considered an operable connection.

Embodiments of the invention include systems and methods for building node embeddings of customer and product information based on structural correlation and feature vectors. Such node embeddings may be used for tasks such as customer classification, link prediction, recommendations for future purchases and/or other use cases. To determine the node embeddings, embodiments of the invention may include five major components: feature matrix creation, creating Laplacian and incidence Matrices, resistance matrix creation, and edge removal and edge addition for resistance matrix.

Various embodiments of the invention are described below.

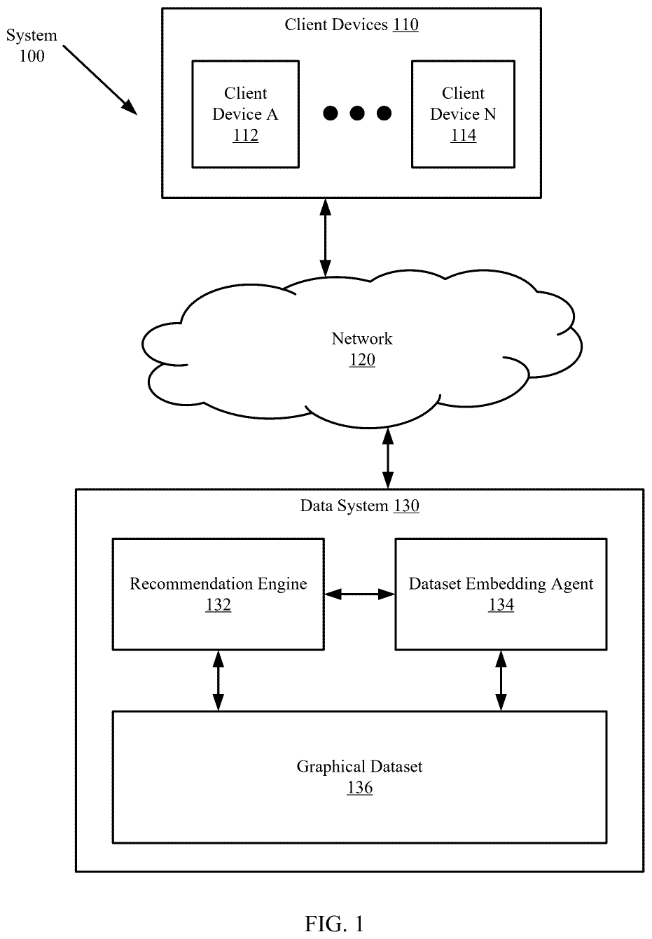

FIG. 1 shows a system in accordance with one or more embodiments of the invention. The system (100) includes any number of client devices (110), a data system (130), and a network (120). The overall system (100) may include additional, fewer, and/or different components without departing from the scope of the invention. Each component may be operably connected to any of the other component via any combination of wired and/or wireless connections. Each component illustrated in FIG. 1 is discussed below.

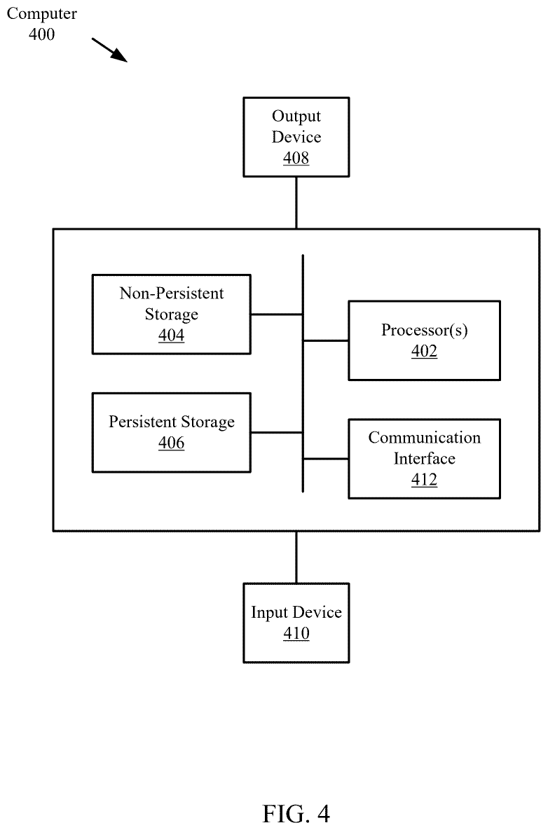

In one or more embodiments, each client device (112, 114) is implemented as a computing device (e.g., 400, FIG. 4). A computing device may be, for example, a mobile phone, a tablet computer, a laptop computer, a desktop computer, a server, a sale terminal, a distributed computing system, or a cloud resource such as a transaction management unit. The computing device may include one or more processors, memory (e.g., RAM), and persistent storage (e.g., disk drives, SSDs, etc.). The computing device may include instructions, stored on the persistent storage, that when executed by the processor(s) of the computing device cause the computing device to perform the functionality of the client device (112, 114) described throughout this present disclosure.

In one or more embodiments of the invention, each client device (112, 114) is implemented as a logical device. A logical device may utilize the computing resources of any number of computing devices (refer to FIG. 4) to provide the functionality of the client device (112, 114) described throughout this present disclosure.

In one or more embodiments, the client devices (110) collectively represent an organization (e.g., an enterprise) that includes any number of users managing data online using the data system (130). The users may access the data via computing devices of the respective client devices (112, 114).

In one or more embodiments, a client device of any client device (112, 114) may issue user queries to the data system (130). A user query may refer to a question, initiated by a user of the client devices (110), that requests information associated with a use case. The query may be for accessing data stored or otherwise processed by the data system (130).

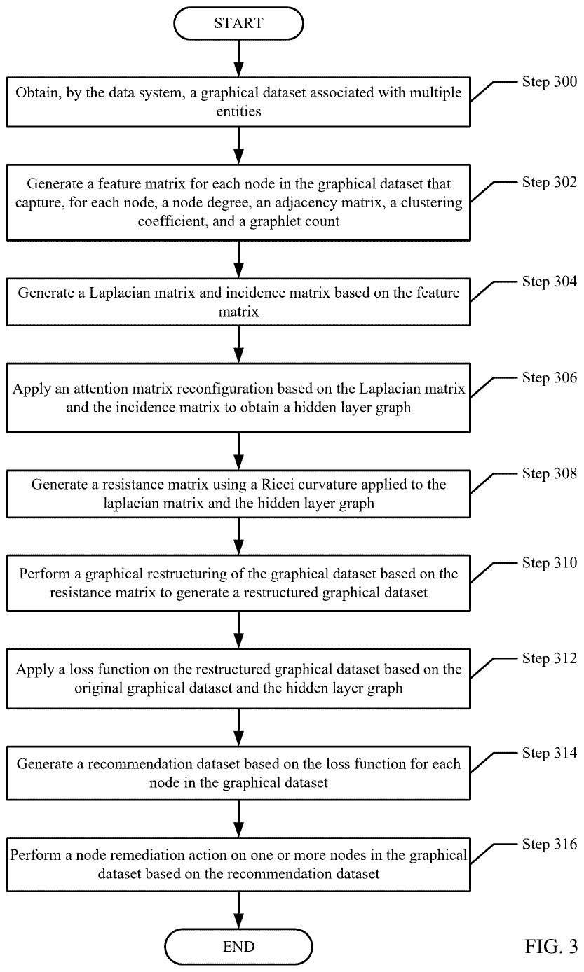

In one or more embodiments, the data system (130) provides the functionality for storing and processing data. The data may be a graphical dataset (136). The processing of the data set may be performed in accordance with the method of FIG. 3. To perform the aforementioned functionality, the data system (130) includes a graphical dataset (136), a dataset embedding agent (134), and a recommendation engine (132). The data system (130) may include additional, different, and/or different components without departing from the invention.

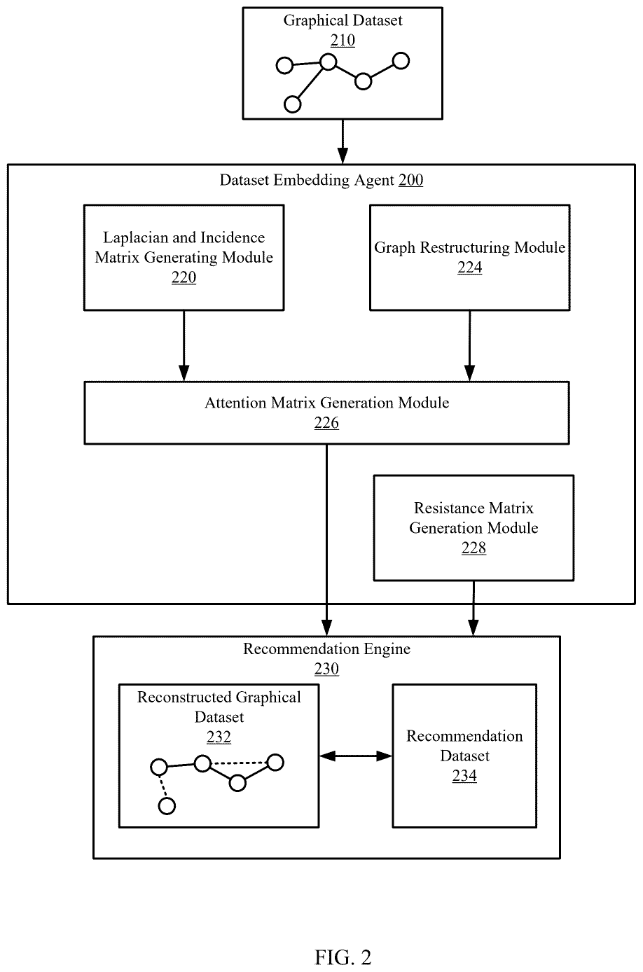

In one or more embodiments, the dataset embedding agent (134) includes functionality for applying node embeddings to nodes in the graphical dataset (136). The data embedding agent (134) may apply the method of FIG. 3 to perform the node embeddings. For additional details regarding the dataset embedding agent (134) and the functionality, refer to FIG. 2.

The recommendation engine (132) may include functionality for using the node embeddings (or any other data generated by the dataset embedding agent (134) to generate recommendations and providing the recommendations to the client devices (110). The recommendation engine (132) may issue recommendations for purchasing additional products to the client devices (110) based on links identified between nodes in the graphical dataset (136). The nodes may each be a user of a client device (112, 114) or a product of an enterprise.

In one or more embodiments, the data system (130) (and/or each component illustrated within) is implemented as a computing device (e.g., 400, FIG. 4). A computing device may be, for example, a mobile phone, a tablet computer, a laptop computer, a desktop computer, a server, a sale terminal, a distributed computing system, or a cloud resource such as a transaction management unit. The computing device may include one or more processors, memory (e.g., RAM), and persistent storage (e.g., disk drives, SSDs, etc.). The computing device may include instructions, stored on the persistent storage, that when executed by the processor(s) of the computing device cause the computing device to perform the functionality of the data system (130) (and/or each component illustrated within) described throughout this present disclosure including the method of FIG. 3.

Alternatively, in one or more embodiments of the invention, the data system (130) (and/or each component illustrated within) is implemented as a logical device. A logical device may utilize the computing resources of any number of computing devices to provide the functionality of the data system (130) (and/or each component illustrated within) described throughout this present disclosure including the method of FIG. 3.

FIG. 2 shows a diagram of a dataset embedding agent in accordance with one or more embodiments of the invention. The dataset embedding agent (200) may be an embodiment of a dataset embedding agent (134, FIG. 1) discussed above. The dataset embedding agent (200) may include a Laplacian and incidence matrix generation module (220), a graph reconstructing module (224), an attention matrix generation module (226), and a resistance matrix generation module (228). The dataset embedding agent (200) may include additional, fewer, and/or different components without departing from the invention.

In one or more embodiments, the Laplacian and incidence matrix generation module (220) includes functionality for generating Laplacian and incidence matrices. Additional matrices generated by the Laplacian and incidence matrix generation module (220) includes, for example, feature matrices, adjacency matrices, and/or any other matrices without departing from the invention. The matrices may be generated for nodes corresponding to the graphical dataset (The matrices may be generated by the Laplacian and incidence matrix generation module (220) in accordance with the method of FIG. 3.

In one or more embodiments, the graph reconstruction module (224) includes functionality for applying a graph neural network (GNN) to generate at least one or more hidden layers of neural network processing. The hidden layers may be further processed with any generated matrices using the attention matrix generation module (226) in accordance with FIG. 3. The matrices may be further used to generate a resistance matrix in accordance with the discussion of FIG. 3. The resistance matrix may be generated using a resistance matrix generation module (228).

The generated data of the dataset embedding agent (200) may be used by the recommendation engine (132) to obtain a reconstructed graphical dataset (232). The reconstructed graphical dataset (232) may include added and/or removed edges between pre-defined nodes in the graphical dataset (136). The reconstructed graphical dataset (232), for example, may indicate additional relationships between nodes not previously established in the graphical dataset (136). Further, the reconstructed graphical dataset (232), for example, may remove previously established relationships that may not be deemed necessary when performing remediation actions in accordance with FIG. 3. The reconstructed graphical dataset (232) may be used to generate a recommendation dataset (234) that specifies each node that corresponds to a customer or user, and recommend to each customer or user one or more products for future purchase.

FIG. 3 shows a flowchart of a method for performing a graphical rewiring of in accordance with one or more embodiments of the invention. The method shown in FIG. 3 may be performed by, for example, a data system (130, FIG. 1.1). Other components of the system illustrated in FIG. 1 may perform the method of FIG. 3 without departing from the invention. While the various steps in the flowchart are presented and described sequentially, one of ordinary skill in the relevant art will appreciate that some or all of the steps may be executed in different orders, may be combined or omitted, and some or all steps may be executed in parallel.

In step 300, a graphical dataset associated with multiple entities is obtained. In one or more embodiments, the graphical dataset (136, FIG. 1) is obtained from storage of the data system. The graphical dataset may specify multiple nodes and relationships between each node. The nodes may each represent a user, a product of an enterprise, an enterprise, and/or any other entity without departing from the invention.

In step 302, a feature matrix is generated for each node in the graphical dataset that each capture, for each node, an adjacency matrix, a clustering coefficient, and a graphlet count. In one or more embodiments, the feature matrix is generated by calculating features for each node and populating the feature matrix with the calculated features for each node. Example features calculated for the feature matrix includes, for example: (i) a node degree that specifies a count of the number of edges (e.g., established relationships between two nodes) connected to the node, (ii) an eigen vector centrality score calculated using the expression

$$\frac{1}{λ} \sum {e}_{v} ,$$

where lambda represents the eigen values and e represents the eigen vectors, the eigen values and eigen vectors calculated using an adjacency matrix, (iii) a clustering coefficient calculated using the expression

$$\frac{ed}{( \frac{kv}{2} )} ,$$

where ed represents the edges among the neighboring nodes and kv is the count of node pairs among the neighboring nodes, and (iv) a graphlet count that indicates the triangle graphlets for the corresponding nodes. Other features may be captured in the feature matrix of a node without departing from the invention.

In step 304, a Laplacian matrix and an incidence matrix is generated based on the feature matrix. In one or more embodiments, the Laplacian matrix is a matrix that represents a difference between a degree matrix and an adjacency matrix. The degree matrix may be a matrix that indicates the node degree of each node in the graphical dataset, and the adjacency matrix may be an adjacency matrix generated in step 302. The incidence matrix may be a matrix K that represents a node by edge matrix that includes a the following conditions for a value of a vertex v and an edge ej: a value of 1 if i=k and i>h, a value of 1 if i=h and i>k, a value of −1 if i=k and i<h, a value of −1 if i=h and i<k.

In one or more embodiments, the significance of using the Laplacian and incidence matrices is inspired from relation continuous multivariate functions and graph theory. In continuous multivariate functions, the first derivative signifies the direction and magnitude of the flow, and the second derivative is the scaler value which signifies the net flow based on the inflow and outflow at a given point. Overlapping the same concept to graph theory, the edges are defined as the first order gradients, given the edges specify the direction of information flow and computed using the incidence matrix. The Laplacian matrix provides the net information flow in the given node with respect to others and is analogous to the second order derivative of multivariate functions.

In step 306, an attention matrix reconfiguration is applied based on the Laplacian matrix and the incidence matrix to obtain a hidden layer graph. In one or more embodiments, the attention matrix reconfiguration includes applying feature engineering information extracted from the matrices generated above, concatenating the obtained information to obtain a feature embedding vector, and applying a graph neural network on the graphical dataset to generate at least one hidden layer. The hidden layer and the feature embedding vector are processed to generate an attention matrix. The attention matrix may be processed with the at least one hidden layer to obtain the hidden layer graph.

In step 308, a resistance matrix is generated using a Ricci curvature applied to the Laplacian matrix and the hidden layer graph. Current approaches to node embeddings may utilize graph neural networks that result in over squashing (i.e., nodes with long term dependencies being diminished over layers of the graph neural network). To preserve such long term dependencies and, in turn, reduce over squashing caused by additional layers of the graph neural network, embodiments of the invention include generating the resistance matrix using Ricci curvatures from Riemannian geometry. The Ricci curvature may be a process for adjusting edges. For example, the subgraphs that are connected with a smaller number of edges where the curvature is less than zero will result in adding edges to make it dense. Similarly, for the edges where the curvature is greater than zero, edges are removed. The resistance matrix for a vertex between nodes i and j may be calculated using the following formula:

$$Resistance Matrix = \frac{2}{{d}_{i}} + \frac{2}{{d}_{j}} - 2 + \frac{2 \cdot Δ}{{D}_{1}} + \frac{Δ}{{D}_{2}} + \frac{1}{γ \cdot {D}_{1}} ( a + b ) ,$$

where Δ is the number of triangles formed with these two nodes, or intersection of neighborhoods between two nodes i and j, a is a number of squares that can be formed with the node being one of the vertices as i without diagonals inside, b is a number of squares that can be formed with the node being one of the vertices as j without diagonals inside, D1 is a maximum of two degrees di and dj, D2 is a minimum of two degrees di and dj, and Y is a maximum of a and b.

In step 310, a graphical restructuring of the graphical dataset is performed based on the original graphical dataset and the hidden layer graph. In one or more embodiments, the graphical restructuring includes applying the graphical dataset to a graph neural network with a limited number of hops or layers (e.g., one or two hops). The hidden layer graph may be resented using the following formula:

$${H}^{[ k + 1 ]} = σ [ Ã {HW}_{k}^{T} + {H}^{( k )} {B}_{k}^{T} ] ,$$

where B and W are the weight metrics and A^{~} is the D⁻¹A, where D is the degree matrix and A is the Adjacency matrix with the H^{[k+1]} is the hidden representation which is the node embeddings of the new graph and dimension of the matrix is (Num of Nodes×Embedding Dimension). Embedding Dimension is generally 64, 128, or 256.

In step 312, a loss function is applied on the restructured graphical dataset based on the original graphical dataset and the hidden layer graph. In one or more embodiments, the loss function is an objective function with the purpose of minimizing the distance between the hidden layer graph and the original graphical dataset. The loss function may be described using the formula:

$${L}_{1} = ‖ {H}_{ref} - H {1}^{[ k + 1 ]} {‖}_{2}$$

In step 314, a recommendation dataset is generated based on the loss function for each node in the graphical dataset. In one or more embodiments, the recommendation dataset is a dataset that maps each node that corresponds to a user or customer to a product that is recommended to the node. Based on the edge removal and addition from the resistance matrix and graphical restructuring, the recommendation dataset specifies relationships between customers and products and identified in the graphical restructuring.

In step 316, a node remediation action is performed on one or more nodes in the graphical dataset based on the recommendation dataset. In one or more embodiments, the node remediation action may include issuing recommendations to the identified customers and/or users in the client devices (110, FIG. 1) discussed above. Another example of a node remediation action includes providing the recommendation dataset to an administrator of the enterprise providing the products for purchase.

As discussed above, embodiments of the invention may be implemented using computing devices. FIG. 4 shows a diagram of a computing device in accordance with one or more embodiments of the invention. The computing device (400) may include one or more computer processors (402), non-persistent storage (404) (e.g., volatile memory, such as random access memory (RAM), cache memory), persistent storage (406) (e.g., a hard disk, an optical drive such as a compact disk (CD) drive or digital versatile disk (DVD) drive, a flash memory, etc.), a communication interface (412) (e.g., Bluetooth interface, infrared interface, network interface, optical interface, etc.), input devices (410), output devices (408), and numerous other elements (not shown) and functionalities. Each of these components is described below.

In one embodiment of the invention, the computer processor(s) (402) may be an integrated circuit for processing instructions. For example, the computer processor(s) may be one or more cores or micro-cores of a processor. The computing device (400) may also include one or more input devices (410), such as a touchscreen, keyboard, mouse, microphone, touchpad, electronic pen, or any other type of input device. Further, the communication interface (412) may include an integrated circuit for connecting the computer (400) to a network (not shown) (e.g., a local area network (LAN), a wide area network (WAN) such as the Internet, mobile network, or any other type of network) and/or to another device, such as another computing device.

In one embodiment of the invention, the computing device (400) may include one or more output devices (408), such as a screen (e.g., a liquid crystal display (LCD), a plasma display, touchscreen, cathode ray tube (CRT) monitor, projector, or other display device), a printer, external storage, or any other output device. One or more of the output devices may be the same or different from the input device(s). The input and output device(s) may be locally or remotely connected to the computer processor(s) (402), non-persistent storage (404), and persistent storage (406). Many different types of computing devices exist, and the aforementioned input and output device(s) may take other forms.

One or more embodiments of the invention may be implemented using instructions executed by one or more processors of the data management device. Further, such instructions may correspond to computer readable instructions that are stored on one or more non-transitory computer readable mediums.

One or more embodiments of the invention may improve the operation of one or more computing devices. More specifically, embodiments of the invention improve the processing of large graphical datasets that include thousands or millions of nodes and sparse edges. For such graphical datasets, embodiments of the invention provide methods for efficiently processing the relationships using feature extractions, graph neural networks with limited hops or layers and calculated matrices processed with the hidden layers of the graph neural networks to obtain additional or fewer edges between the nodes. Specifically, the modifications to the edges of the nodes may provide additional insight into the relationships between nodes such as customers and their corresponding products, to identify potential recommendations for customers likely to purchase additional products based on long term dependencies between the customers and previously purchased products. By utilizing graph neural networks with limited hops and layers and the feature extractions, such relationships may be identified while reducing the cognitive burden applied to users associated with the enterprise selling such products.

Thus, embodiments of the invention may address the problem of inefficient use of computing resources. This problem arises due to the technological nature of the environment in which file systems are utilized.

The problems discussed above should be understood as being examples of problems solved by embodiments of the invention disclosed herein and the invention should not be limited to solving the same/similar problems. The disclosed invention is broadly applicable to address a range of problems beyond those discussed herein.

While the invention has been described above with respect to a limited number of embodiments, those skilled in the art, having the benefit of this disclosure, will appreciate that other embodiments can be devised which do not depart from the scope of the invention as disclosed herein. Accordingly, the scope of the invention should be limited only by the attached claims.

What is claimed is:

1. A method for managing a graphical dataset, the method comprising:
generating a feature matrix for each node of a plurality of nodes in the graphical dataset, wherein the graphical dataset comprises the plurality of nodes and relationships between each of the plurality of nodes;
generating a Laplacian matrix for each node of the plurality of nodes;
generating a resistance matrix for each pair of nodes in the plurality of nodes using a Ricci curvature applied to the Laplacian matrix;
performing a graphical restructuring of the graphical dataset based on the resistance matrix,
wherein the graphical restructuring comprises modifying at least one of the relationships; and
performing a node remediation action on at least one node in the graphical dataset based on the graphical restructuring.

2. The method of claim 1, further comprising:
generating an incidence matrix based on the feature matrix; and
performing an attention matrix reconfiguration based on the Laplacian matrix and the incidence matrix to obtain a hidden layer graph,
wherein the resistance matrix is further generated based on the hidden layer graph.

3. The method of claim 2, further comprising:
applying a loss function based on the graphical restructuring using the hidden layer graph.

4. The method of claim 1, wherein performing the graphical restructuring comprises removing the at least one of the relationships.

5. The method of claim 1, wherein performing the graphical restructuring comprises establishing a second relationship between two of the plurality of nodes in the graphical dataset.

6. The method of claim 1, wherein each node of the plurality of nodes represents one of: a user that has purchased one of a plurality of products of an enterprise, and one of the plurality of products.

7. The method of claim 6, wherein the node remediation action comprises displaying a recommendation for the user to purchase a second product of the plurality of products, wherein a relationship between the user and the second product is not established in the graphical dataset.

8. A non-transitory computer readable medium comprising computer readable program code, which when executed by a computer processor enables the computer processor to perform a method for managing a graphical dataset, the method comprising:
generating a feature matrix for each node of a plurality of nodes in the graphical dataset, wherein the graphical dataset comprises the plurality of nodes and relationships between each of the plurality of nodes;
generating a Laplacian matrix for each node of the plurality of nodes;
generating a resistance matrix for each pair of nodes in the plurality of nodes using a Ricci curvature applied to the Laplacian matrix;
performing a graphical restructuring of the graphical dataset based on the resistance matrix,
wherein the graphical restructuring comprises modifying at least one of the relationships; and
performing a node remediation action on at least one node in the graphical dataset based on the graphical restructuring.

9. The non-transitory computer readable medium of claim 8, further comprising:
generating an incidence matrix based on the feature matrix; and
performing an attention matrix reconfiguration based on the Laplacian matrix and the incidence matrix to obtain a hidden layer graph,
wherein the resistance matrix is further generated based on the hidden layer graph.

10. The non-transitory computer readable medium of claim 9, further comprising:
applying a loss function based on the graphical restructuring using the hidden layer graph.

11. The non-transitory computer readable medium of claim 8, wherein performing the graphical restructuring comprises removing the at least one of the relationships.

12. The non-transitory computer readable medium of claim 8, wherein performing the graphical restructuring comprises establishing a second relationship between two of the plurality of nodes in the graphical dataset.

13. The non-transitory computer readable medium of claim 8, wherein each node of the plurality of nodes represents one of: a user that has purchased one of a plurality of products of an enterprise, and one of the plurality of products.

14. The non-transitory computer readable medium of claim 13, wherein the node remediation action comprises displaying a recommendation for the user to purchase a second product of the plurality of products, wherein a relationship between the user and the second product is not established in the graphical dataset.

15. A system, comprising:
a data system operating on a processor; and
memory comprising instructions, which when executed by the processor, perform a method comprising:
generating a feature matrix for each node of a plurality of nodes, wherein a graphical dataset comprises the plurality of nodes and relationships between each of the plurality of nodes;
generating a Laplacian matrix for each node of the plurality of nodes;
generating a resistance matrix for each pair of nodes in the plurality of nodes using a Ricci curvature applied to the Laplacian matrix;
performing a graphical restructuring of the graphical dataset based on the resistance matrix,
wherein the graphical restructuring comprises modifying at least one of the relationships; and
performing a node remediation action on at least one node in the graphical dataset based on the graphical restructuring.

16. The system of claim 15, further comprising:
generating an incidence matrix based on the feature matrix;
performing an attention matrix reconfiguration based on the Laplacian matrix and the incidence matrix to obtain a hidden layer graph, wherein the resistance matrix is further generated based on the hidden layer graph; and
applying a loss function based on the graphical restructuring using the hidden layer graph.

17. The system of claim 15, wherein performing the graphical restructuring comprises removing the at least one of the relationships.

18. The system of claim 15, wherein performing the graphical restructuring comprises establishing a second relationship between two of the plurality of nodes in the graphical dataset.

19. The system of claim 15, wherein each node of the plurality of nodes represents one of: a user that has purchased one of a plurality of products of an enterprise, and one of the plurality of products.

20. The system of claim 19, wherein the node remediation action comprises displaying a recommendation for the user to purchase a second product of the plurality of products, wherein a relationship between the user and the second product is not established in the graphical dataset.
